(19) United States
(12) Patent Application Publication
(10) Pub. No.: US 2025/0208572 A1
(43) Pub. Date: Jun. 26, 2025

(54) COMPOSITE COMPONENT OF A HOROLOGICAL REGULATING MECHANISM COMPRISING A MASS

(71) Applicant: Montres Breguet S.A., L'Abbaye (CH)

(72) Inventors: Younes KADMIRI, Montfaucon (FR); Daniel MATTEAZZI, Le Sentier (CH); Grégory GAUTHIER, Saint-Cergue (CH)

(73) Assignee: Montres Breguet S.A., L'Abbaye (CH)

(21) Appl. No.: 18/973,416

(22) Filed: Dec. 9, 2024

(30) Foreign Application Priority Data
Dec. 22, 2023 (EP) 23219730.1

(51) Int. Cl. G04B 15/14

(52) U.S. Cl. CPC G04B 15/14

(57) ABSTRACT

A composite timepiece component of a regulating mechanism of a watch, including pallets having a staff on which is arranged an axial shoulder, the pallets being provided with pallet-stones intended to interact intermittently with an escape wheel set, the composite component further including a mass fastened to the pallets, the mass being made of a denser material than that constituting the pallets, so that the mass has a maximum radial dimension smaller than or identical to the maximum radial dimension of the pallets.

### TECHNICAL FIELD OF THE INVENTION

The invention relates to the field of watchmaking and in particular to components of horological movements.

The invention relates to a composite timepiece component comprising a mass. The composite component is a component of a regulating mechanism.

### TECHNOLOGICAL BACKGROUND

Controlling the inertia of components of timepiece mechanisms, and in particular of components of regulating mechanisms, is essential because the dynamic behaviour of these components depends on their inertia.

The production of timepiece components using micro-manufacturing processes such as “LIGA” (from the German “Lithographische Galvano Abformung” meaning “galvanic patterning by lithography”), or the like, produces components with a very fine geometry, optimising functional contacts. However, these components are very light, and a certain amount of inertia is often required to maintain motion, provide a pulse, or perform another function.

For example, in a regulating mechanism operating on the basis of repeated impacts between an escape wheel set and pallets, the frequency of oscillation is partly dependent on the inertia of the pallets. Moreover, the mechanical stresses applied to the escape wheel set and to the pallets are relatively high as a result of the repeated impacts, making the choice of materials for their interaction surfaces important.

Moreover, in certain circumstances, a particular inertia must be obtained for the pallets while complying with space restrictions in the horological movement in which it is intended to be arranged.

### SUMMARY OF THE INVENTION

The invention relates to a composite timepiece component of a regulating mechanism, said composite component comprising a mass allowing its inertia to be controlled.

More specifically, the invention relates to a composite timepiece component of a regulating mechanism of a watch, comprising pallets having a staff on which an axial shoulder is arranged, said pallets being provided with pallet-stones intended to interact intermittently with an escape wheel set. The composite component further comprises a mass fastened to the pallets, said mass being made of a denser material than that constituting the pallets so that the mass has a maximum radial dimension smaller than or identical to a maximum radial dimension of the pallets.

The present invention thus makes it possible, on the one hand, to withstand the mechanical stresses to which the pallets of regulating mechanisms are subjected and, on the other hand, to control the inertia of the composite component, while allowing it to retain small dimensions and thus to be used in horological movements with high space restrictions.

In particular embodiments, the invention can further include one or more of the following features, which must be considered singly or according to any combination technically possible.

In particular embodiments, the mass is made from a material with a density greater than 15.

In particular embodiments, the mass is made from a material with a density preferably greater than 19.

In particular embodiments, the mass is made of gold, platinum or their alloys.

In particular embodiments, the mass is arranged such that it bears against the axial shoulder, in a manner opposing the pallet-stones.

In particular embodiments, the mass has a central through-hole via which it is driven onto the pallet-staff.

In particular embodiments, the mass comprises a stack of a plurality of rotationally symmetrical elements.

### BRIEF DESCRIPTION OF THE FIGURES

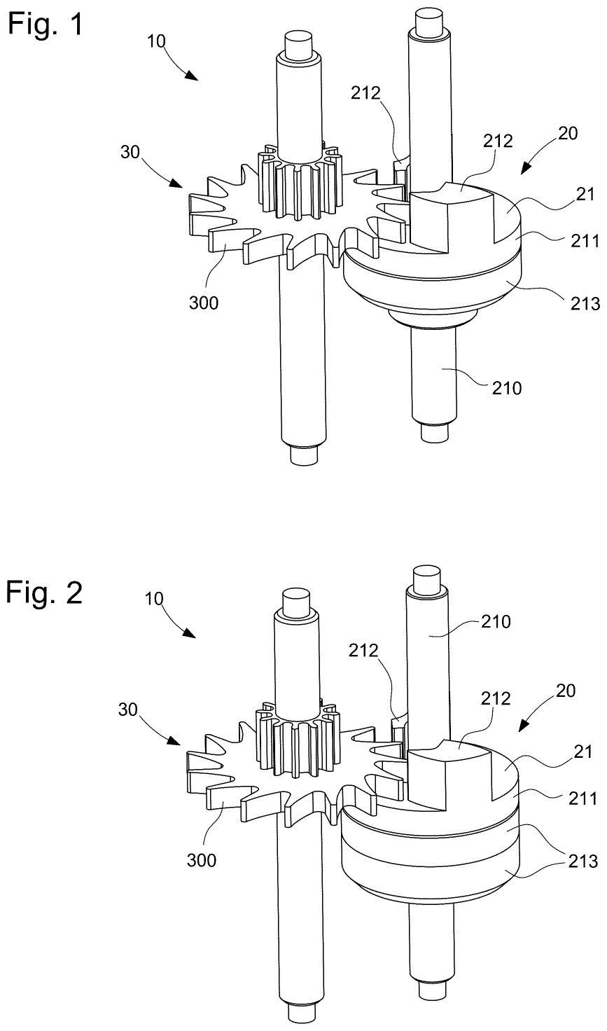

The purposes, advantages and features of the invention will become clearer on reading the detailed description that follows, which is given with reference to the accompanying drawings, in which FIGS. 1 and 2 illustrate a perspective view of a composite timepiece component respectively according to a preferred embodiment of the present invention, and according to another embodiment of the invention.

### DETAILED DESCRIPTION OF THE INVENTION

The invention relates to a composite timepiece component 20 of a regulating mechanism 10 of a horological movement of a watch, which component is arranged so as to be able to pivot about an axis of rotation.

Such a regulating mechanism 10 is particularly suitable for regulating the drive of a date, for example as described in the European patent EP3540524.

As shown in FIG. 1, the composite component 20 comprises pallets 21 formed in one piece from a single material. The pallets 21 have a staff 210 on which is arranged an axial shoulder 211, for example that is rotationally symmetrical about the axis of rotation D. The staff 210 extends along the axis of rotation of the composite wheel set. The pallets 21 also have pallet-stones 212, for example arranged on the axial shoulder 211 and intended to interact intermittently with an escape wheel set 30, and in particular with a toothing 300 thereof, as illustrated in FIG. 1. The interaction of the pallet-stones 212 with the toothing 300 of the escape wheel set 30 defines alternating impacts between one or other of the pallet-stones 212 and the teeth of the toothing 300. In one example embodiment of the invention, the pallet-stones 212 can form the axial shoulder 211, and thus extend radially from the staff 210.

In order to mechanically resist the stresses resulting from the interaction between the pallet-stones 212 and the toothing 300, the pallets 21 are made of a suitable material, for example titanium, ceramic, cupro beryllium, etc. The pallets 21 can also have a coating, for example a coating within the reach of a person skilled in the art, such as nickel phosphorus.

In order to have an appropriate inertia to suit the regulating function of the regulating mechanism 10, the composite component 20 comprises a mass 213 fastened to the pallets 21. In particular, the mass 213 bears against the axial shoulder 211, in a manner opposing the pallet-stones 212. For example, the mass 213 is driven onto the pallets 21. For this purpose, in particular, the mass 213 has a central through-hole, through which the staff 210 of the pallets 21 is engaged when the mass 213 is being driven.

The mass 213 is made of a denser material than that constituting the pallets 21, and is chosen so that the mass 213 has a maximum radial dimension smaller than or identical to the maximum radial dimension of the pallets 21. In other words, the material of the mass 213 is chosen so that the maximum radial dimension of the mass 213 does not impact the maximum radial envelope of the composite component 20, given the space restrictions of the horological movement. As can be seen from FIGS. 1 and 2, the mass 213 is advantageously rotationally symmetrical about the axis of rotation of the composite component 20.

The mass 213 is preferably made of gold, but can be made of any other material with a density greater than 15, preferably 19, for example platinum or a gold or platinum alloy.

In the preferred example embodiment of the invention shown in FIG. 1, the mass 213 consists of a single, rotationally symmetrical element. However, it is possible, in another example embodiment of the invention, for the mass 213 to comprise a stack of a plurality of rotationally symmetrical elements, as shown in FIG. 2. This feature has the advantage of being able to adjust the volume of the mass 213, and thus its mass, and as a result the inertia of the composite component 20.

To summarise, thanks to the fact that it is composite, i.e. made from two different materials, the composite component 20 has the desired inertia depending on the function it is to perform, while occupying the smallest possible effective volume.

Advantageously, the composite component 20 replaces the non-weighted base component.

1. A composite timepiece component of a regulating mechanism of a watch, wherein the composite timepiece comprises pallets having a staff on which is arranged an axial shoulder, said pallets being provided with pallet-stones intended to interact intermittently with an escape wheel set, the composite component further comprising a mass fastened to the pallets, said mass being made of a denser material than that constituting the pallets, so that the mass has a maximum radial dimension smaller than or identical to the maximum radial dimension of the pallets.

2. The composite component according to claim 1, wherein the mass is made from a material with a density greater than 15.

3. The composite component according to claim 1, wherein the mass is made from a material with a density greater than 19.

4. The composite component according to claim 1, wherein the mass is made of gold, platinum or their alloys.

5. The composite component according to claim 1, wherein the mass bears against the axial shoulder , in a manner opposing the pallet-stone.

6. The composite component according to claim 1, wherein the mass comprises a central through-hole via which it is driven onto the staff of the pallets.

7. The composite component according to claim 1, wherein the mass comprises a stack of a plurality of rotationally symmetrical elements.
